(19) United States
(12) Patent Application Publication
(10) Pub. No.: US 2026/0041594 A1
(43) Pub. Date: Feb. 12, 2026

(54) FIBER REINFORCED POLYMER COMPOSITE SLIDER BOARD

(71) Applicant: Brett Louis BUTLER, Encinitas, CA (US)

(72) Inventor: Brett Louis BUTLER, Encinitas, CA (US)

(21) Appl. No.: 19/361,557

(22) Filed: Oct. 17, 2025

Related U.S. Application Data
(63) Continuation of application No. 18/424,628, filed on Jan. 26, 2024.

(51) Int. Cl. A61G 7/10; B32B 3/08; B32B 3/30; B32B 5/02; B32B 5/26

(52) U.S. Cl. CPC A61G 7/103; B32B 3/085; B32B 3/30; B32B 5/02; B32B 5/26; B32B 2262/101; B32B 2262/106; B32B 2307/558; B32B 2307/744; B32B 2535/00

(57) ABSTRACT

A fiber reinforced polymer composite slider board comprises a composite structure having a thickness of 2-6 mm and configured to support a person weighing up to 200 kg while bridging a gap of up to 300 mm between seating surfaces. The composite structure comprises multiple layers of fiber reinforced polymer materials including carbon fibers, glass fibers, or aramid fibers embedded in a polymer matrix of epoxy, polyester, or thermoplastic resins. The slider board includes a smooth top surface for sliding movement during transfer and a roughened bottom surface for slip resistance. The roughened surface is formed by applying a peel ply layer that creates texture when removed after curing. The composite structure is manufactured using vacuum assisted resin transfer molding to enable autoclave sterilization.

### CROSS-REFERENCE TO RELATED APPLICATIONS

This application is a continuation-in-part of U.S. application Ser. No. 18/424,628, entitled SLIDER BOARD, filed Jan. 26, 2024, which is hereby incorporated by reference in its entirety.

### FIELD OF INVENTION

The present disclosure relates to mobility aids for transferring individuals between seating surfaces, and more particularly to a fiber reinforced polymer composite slider board that provides a lightweight, strong, and smooth transfer surface for seniors and individuals with mobility limitations.

### BACKGROUND

As the population ages, many seniors and individuals with mobility limitations face challenges when transferring between different seating surfaces such as beds, wheelchairs, chairs, and toilets. These transfers can be physically demanding and potentially dangerous for both the individual and their caregivers, particularly when the person has weakened leg muscles or cannot stand independently.

Traditional transfer aids, commonly known as slider boards, have been developed to assist with these mobility challenges. Conventional slider boards are typically constructed from wood or polymer materials and generally measure between 12-25 mm in thickness, 250 mm in width, and 600-900 mm in length. These boards typically weigh between 3 to 5 kg, making them relatively heavy and cumbersome for frequent use.

The materials used in conventional slider boards present several limitations. Wood-based slider boards, while providing adequate strength, are susceptible to moisture damage and cannot withstand sterilization processes such as autoclaving. Additionally, wood surfaces tend to have a matte finish that may not provide optimal sliding characteristics. Polymer-based slider boards, while offering some improvements in surface smoothness and moisture resistance, still require substantial thickness to achieve the structural integrity needed to support user weight safely.

The weight and bulk of conventional slider boards can pose challenges for users and caregivers. The substantial mass makes the boards difficult to position and maneuver, particularly for individuals with limited upper body strength. Furthermore, the thickness of these boards can create awkward height differentials between seating surfaces, potentially making transfers more difficult or uncomfortable.

Surface characteristics also play a role in transfer effectiveness. Many conventional slider boards have surfaces that are not optimally smooth, which can increase friction and make sliding more difficult. Additionally, the bottom surfaces of these boards may lack adequate grip features to prevent unwanted movement during transfers.

Sterilization and hygiene considerations are increasingly important in healthcare and home care environments. Many conventional slider board materials cannot withstand high-temperature sterilization processes, limiting their use in clinical settings where infection control is paramount.

There exists a need for transfer aids that combine reduced weight and thickness with enhanced strength, improved surface characteristics for easier sliding, and the ability to withstand sterilization processes while maintaining structural integrity and safety.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a fiber reinforced polymer composite slider board is provided. The slider board includes a composite structure having a thickness dimension of 2-6 mm and configured to support a person weighing up to 200 kg while bridging a gap of up to 300 mm between seating surfaces. The composite structure comprises multiple layers of fiber reinforced polymer materials including at least one layer of carbon fibers, glass fibers, or aramid fibers embedded in a polymer matrix selected from epoxy, polyester, or thermoplastic resins. The slider board has a smooth top surface configured to facilitate sliding movement of a person during transfer between seating surfaces. The slider board includes a roughened bottom surface configured to provide slip resistance against underlying surfaces during transfer operations.

According to other aspects of the present disclosure, the slider board may include one or more of the following features. The composite structure may have a length dimension of 500-900 mm and a width dimension of 250-400 mm. The slider board may weigh between 0.7-2.7 kg. The multiple layers may include unidirectional fiber layers oriented parallel to the length dimension to provide bridging strength and torsional rigidity. The fiber layers may comprise basket weave, twill, satin weave, or unidirectional fiber orientations. The polymer matrix may comprise epoxy resin, polyester resin, or polyvinyl acetate resin. The roughened bottom surface may be formed during manufacturing by application of a peel ply layer that creates the textured surface when removed after curing. The slider board may include slip resistant pads positioned at opposing ends of the board, wherein the slip resistant pads comprise foam polymer materials with sculptured bottom surfaces. The slip resistant pads may have a width of approximately 75 mm and a thickness of approximately 2 mm. The composite structure may be manufactured using vacuum assisted resin transfer molding process to enable sterilization in an autoclave.

According to another aspect of the present disclosure, a method of manufacturing a fiber reinforced polymer composite slider board is provided. The method includes layering multiple fiber reinforced materials in a predetermined sequence, wherein the fiber reinforced materials include at least one layer of carbon fibers, glass fibers, or aramid fibers. The method includes applying a peel ply layer as a final layer to create a roughened surface texture. The method includes infusing the layered materials with a polymer resin using vacuum assisted resin transfer molding. The method includes curing the resin-infused materials to form a rigid composite structure. The method includes removing the peel ply layer after curing to reveal the roughened bottom surface.

According to other aspects of the present disclosure, the manufacturing method may include one or more of the following features. The predetermined sequence may include a first layer of E-glass material with plain weave pattern, followed by alternating layers of carbon fiber materials with plain weave and unidirectional orientations. The polymer resin may be selected from epoxy, polyester, or thermoplastic materials. The curing process may be conducted under conditions that allow the resulting slider board to withstand autoclave sterilization temperatures. The method may include forming the composite structure to have a thickness of 2-6 mm and dimensions suitable for supporting loads up to 200 kg across gaps of up to 300 mm.

Another aspect of the present disclosure involves a fiber reinforced polymer composite slider board comprising a composite structure having a thickness of 2-6 mm and configured to support a person weighing up to 200 kg while bridging a gap of up to 300 mm between seating surfaces, the composite structure comprising multiple layers of fiber reinforced polymer materials including at least one layer of carbon fibers, glass fibers, or aramid fibers embedded in a polymer matrix selected from epoxy, polyester, or thermoplastic resins; a smooth top surface configured to facilitate sliding movement of a person during transfer between seating surfaces; and a roughened bottom surface configured to provide slip resistance against underlying surfaces during transfer operations.

One or more implementations of the aspect of the disclosure described immediately above includes one or more of the following: the composite structure has a length dimension of 500-900 mm and a width dimension of 250-400 mm; the slider board weighs between 0.7-2.7 kg; the multiple layers include unidirectional fiber layers oriented parallel to a length dimension of the slider board to provide bridging strength and torsional rigidity; the fiber layers comprise basket weave, twill, satin weave, or unidirectional fiber orientations; the polymer matrix comprises epoxy resin, polyester resin, or polyvinyl acetate resin; the roughened bottom surface is formed during manufacturing by application of a peel ply layer that creates a textured surface when removed after curing; slip resistant pads positioned at opposing ends of the slider board, wherein the slip resistant pads comprise foam polymer materials with sculptured bottom surfaces; the slip resistant pads have a width of approximately 75 mm and a thickness of approximately 2 mm; and/or the composite structure is manufactured using vacuum assisted resin transfer molding process to enable sterilization in an autoclave.

A further aspect of the present disclosure involves a method of manufacturing a fiber reinforced polymer composite slider board comprising a step of layering multiple fiber reinforced materials in a predetermined sequence, wherein the fiber reinforced materials include at least one layer of carbon fibers, glass fibers, or aramid fibers; a step of applying a peel ply layer as a final layer to create a roughened surface texture; a step of infusing the layered materials with a polymer resin using vacuum assisted resin transfer molding; a step of curing the resin-infused materials to form a rigid composite structure having a thickness of 2-6 mm and configured to support loads up to 200 kg across gaps of up to 300 mm; and a step of removing the peel ply layer after curing to reveal the roughened bottom surface.

One or more implementations of the aspect of the disclosure described immediately above includes one or more of the following: the predetermined sequence includes a first layer of E-glass material with plain weave pattern, followed by alternating layers of carbon fiber materials with plain weave and unidirectional orientations; the carbon fiber materials comprise 3K 200 gsm plain weave layers and C-LA-0912 vector ply unidirectional weave layers; the polymer resin is selected from epoxy, polyester, or thermoplastic materials; and/or the step of curing is conducted under conditions that allow the resulting slider board to withstand autoclave sterilization temperatures.

A still further aspect of the present disclosure involves a transfer system for mobility assistance comprising a fiber reinforced polymer composite slider board having a composite structure with a thickness of 2-6 mm, a length of 500-900 mm, and a width of 250-400 mm, the composite structure comprising multiple layers of fiber reinforced materials including carbon fibers or glass fibers embedded in a polymer matrix, wherein the slider board has a smooth top surface and a roughened bottom surface formed by removal of a peel ply layer during manufacturing; and slip resistant pads positioned at opposing ends of the slider board, wherein the slip resistant pads comprise foam polymer materials with sculptured bottom surfaces configured to prevent slipping during transfer operations between seating surfaces.

One or more implementations of the aspect of the disclosure described immediately above includes one or more of the following: the slip resistant pads have a width of approximately 75 mm and a thickness of approximately 2 mm; the slip resistant pads comprise Ethyl Vinyl Acetate foam polymer with deeply sculptured bottom surfaces configured like boat deck pads; the composite structure is manufactured using vacuum assisted resin transfer molding process to enable sterilization in an autoclave; and/or the multiple layers include unidirectional fiber layers oriented parallel to the length of the slider board to provide bridging strength and torsional rigidity for supporting loads up to 200 kg across gaps of up to 300 mm.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates top, side, and bottom views of a slider board with slip resistant pads, according to aspects of the present disclosure.

FIG. 2 illustrates top, side, and bottom views of the slider board with a roughened surface, according to aspects of the present disclosure.

FIG. 3 illustrates a slider board bridging between a bed and wheelchair for person transfer, according to aspects of the present disclosure.

FIG. 4 illustrates a slider board with a curved portion bridging between a toilet and wheelchair, according to aspects of the present disclosure.

FIG. 5 illustrates top and bottom views of a fiber reinforced polymer composite slider board, according to aspects of the present disclosure.

FIG. 6 illustrates the slider board of FIG. 5 bridging between a bed and wheelchair, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

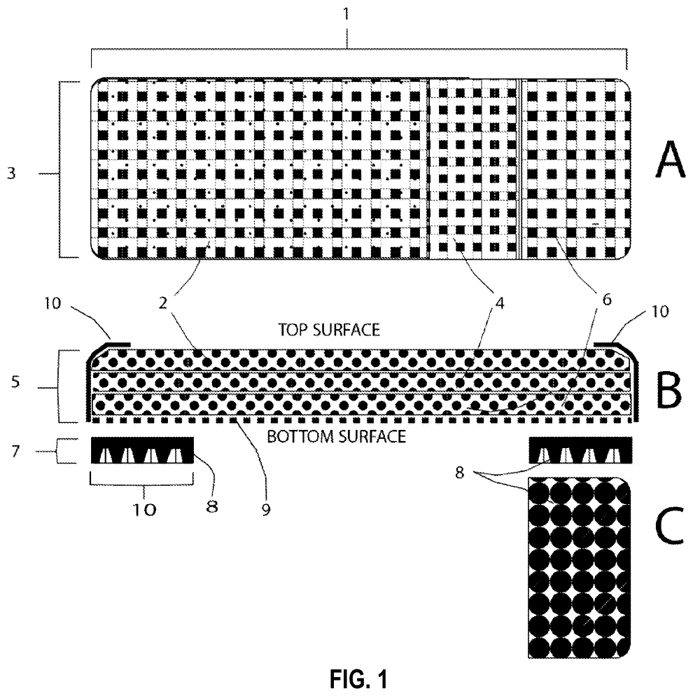

Referring to FIG. 1, a fiber reinforced polymer composite slider board includes a composite structure having a length dimension 1 of about 500-750 mm (24-30 in.), a width dimension 3 of about 250-400 mm (10-15 in.), and a thickness dimension 5 of about 2.5-3.5 mm (0.10-0.14 in.). The composite structure may be configured to support a person weighing up to 200 kg while bridging a gap of up to 300 mm between seating surfaces. The slider board may weigh approximately 0.7-2 kg (1.6-4.4 lb.).

The composite structure may comprise multiple layers of fiber reinforced polymer materials. As shown in FIG. 1, the composite structure includes a top layer 2, a center layer 4, and a bottom layer 6. The top layer 2 may comprise a composite consisting of a polymer matrix with embedded layers of graphite and/or glass fibers. The polymer matrix may be selected from epoxy, polyester/chemical curing resins, or thermoplastic polyvinyl-acetate resins. The center layer 4 may consist of a fiber reinforced polymer of woven fiber or fiber mat positioned between the top layer 2 and the bottom layer 6. The bottom layer 6 may be different from or may mirror the top layer 2.

The fiber layers may comprise various weave patterns including basket weave, twill, satin weave, or unidirectional fiber orientations. In some cases, the multiple layers include unidirectional fiber layers oriented parallel to the length dimension 1 to provide bridging strength and torsional rigidity. The fiber weave patterns may include basket weaving, satin weave, twill, or oriented mats to provide strength in the long axis of the board and torsional rigidity and transverse strength. The outer surface layers of woven glass or graphite fiber layers may provide a three-dimensional appearance to the slider board surface.

With continued reference to FIG. 1, the top layer 2 may provide a smooth top surface configured to facilitate sliding movement of a person during transfer between seating surfaces. The smooth top surface may have a glassy finish that enhances the sliding characteristics. A gripping surface 9 may be provided on the bottom surface and may be roughened either during or after processing to provide slip resistance against underlying surfaces during transfer operations. The roughened bottom surface may have embossed diamond patterns or other patterns of high and low gripping surfaces.

The slider board may further comprise slip resistant pads 8 positioned at opposing ends of the board. As shown in FIG. 1, the slip resistant pads 8 may have a pad width 10 of about 75 mm (3 in.) and a pad thickness 7 of about 2 mm (0.83 in.). The slip resistant pads 8 may comprise foam polymer materials with sculptured bottom surfaces to prevent slipping. In some cases, the slip resistant pads 8 may be made of foam rubber, Ethyl Vinyl Acetate, or similar waterproof foam polymer. The slip resistant pads 8 may have deeply sculptured bottom surfaces like boat deck pads to enhance slip resistance.

The edges of the board may have a smooth layer of fiber composite or polymer tape for edge finishing. The edge finishing materials may provide a smooth transition and may protect the layered structure of the composite materials. The surface pattern variations for the roughened bottom surface may include various textured patterns designed to provide grip without scratching the surfaces on which the slider board rests.

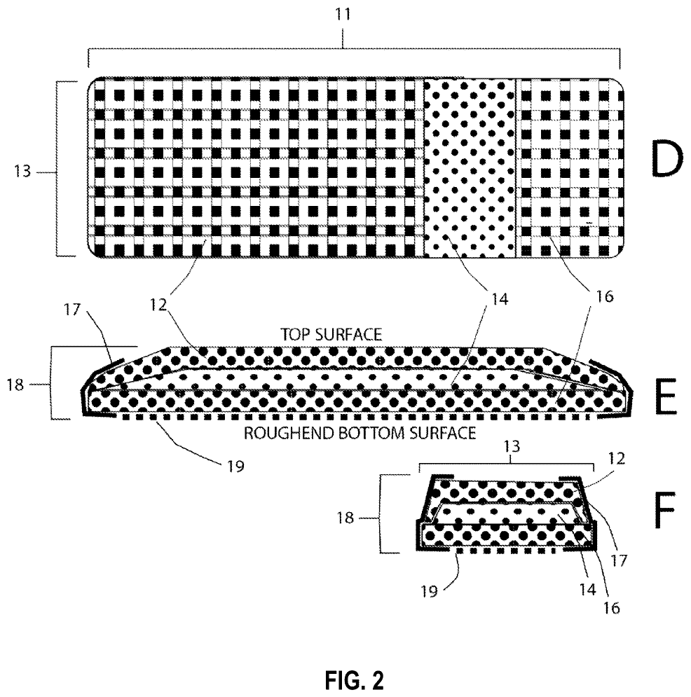

Referring to FIG. 2, an alternative embodiment of the fiber reinforced polymer composite slider board includes a thicker construction with enhanced structural properties. The slider board may have a length dimension 11 of about 500-750 mm (24-30 in.), a width dimension 13 of about 250-400 mm (10-15 in.), and a thickness dimension 18 of about 6-14 mm (0.25-0.55 in.). The slider board may weigh approximately 0.9-2.7 kg (2.0-6.0 lb.).

The composite structure may comprise a top layer 12, a center layer 14, and a bottom layer 16. The top layer 12 may be composed of a composite consisting of a polymer matrix of epoxy or polyester/chemical curing resins or thermoplastic polyvinyl-acetate resins with embedded layers of graphite and/or glass fibers. The fiber arrangements may include basket weaving, satin weave, twill, or oriented mats to provide strength in the long axis of the board and torsional rigidity, transverse strength, and a smooth surface. The top layer 12 and the bottom layer 16 may be different from each other or may be mirror images of each other.

As shown in FIG. 2, the center layer 14 may consist of various core materials selected to provide structural support while maintaining lightweight characteristics. The center layer 14 may consist of dense polymer foam such as polystyrene polyester or polyvinyl acetate. In some cases, the center layer 14 may comprise wood or urea formaldehyde paper laminates such as Formica. The center layer 14 may alternatively comprise fiberglass polymer of woven tow or fabric or three-dimensional fiber mat materials.

With continued reference to FIG. 2, an edge layer 17 may be provided along the edges of the board to provide a smooth finish. The edge layer 17 may comprise a smooth layer of fiber composite or polymer tape that protects the layered structure and provides a finished appearance to the board edges. The bottom layer 16 may include a roughened surface 19 that may be created either during or after processing to provide slip resistant gripping characteristics. The roughened surface 19 may prevent the slider board from moving relative to underlying surfaces during transfer operations. In some cases, additional slip resistant pads may be added to enhance slip resistance properties of the roughened surface 19.

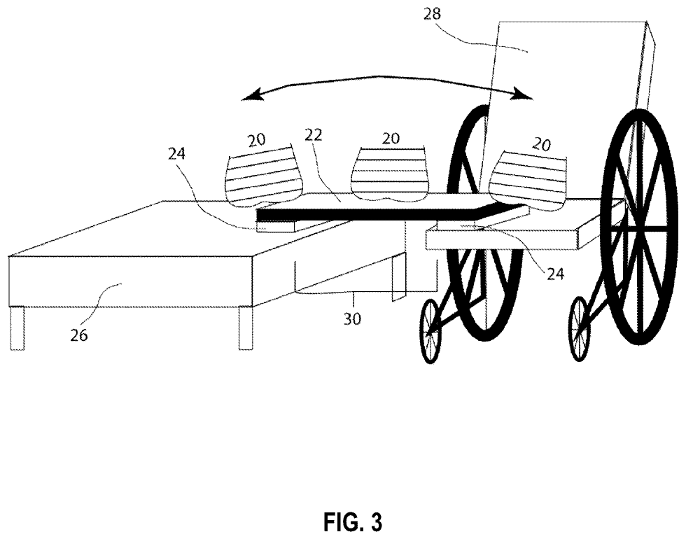

Referring to FIG. 3, a slider board 22 may be configured for transferring a person 20 between a bed 26 and a wheelchair 28. The slider board 22 may be positioned to span across a transfer gap 30 that extends between the bed 26 and the wheelchair 28. The slider board 22 may provide a transfer surface that enables the person 20 to slide from one seating position to another without requiring the person 20 to stand or walk independently.

The slider board 22 may include an anti-slip grip 24 positioned on the surface of the slider board 22. The anti-slip grip 24 may be configured to provide additional traction for the person 20 during transfer operations while maintaining the sliding characteristics of the transfer surface. In some cases, the anti-slip grip 24 may be strategically positioned to enhance safety during the transfer process without impeding the sliding motion.

As shown in FIG. 3, the slider board 22 may be configured to bridge gaps between seating surfaces ranging from 250-375 mm (10-15 in.). The gap bridging capacity may extend up to 381 mm (15 inches) depending on the specific application and seating arrangement. The slider board 22 may maintain structural integrity and load-bearing capacity while spanning these distances, providing a stable transfer surface for the person 20.

With continued reference to FIG. 3, the wheelchair 28 may be locked in position to prevent movement during the transfer operation. The bed 26 and the wheelchair 28 may be positioned at different heights, and the slider board 22 may accommodate height differences while providing a smooth transition surface. The seating surface may extend across the length of the slider board 22, allowing bidirectional movement between the wheelchair 28 and the bed 26. The transfer process may be facilitated by the smooth top surface of the slider board 22 while the bottom surface maintains grip against the underlying surfaces of the bed 26 and wheelchair 28.

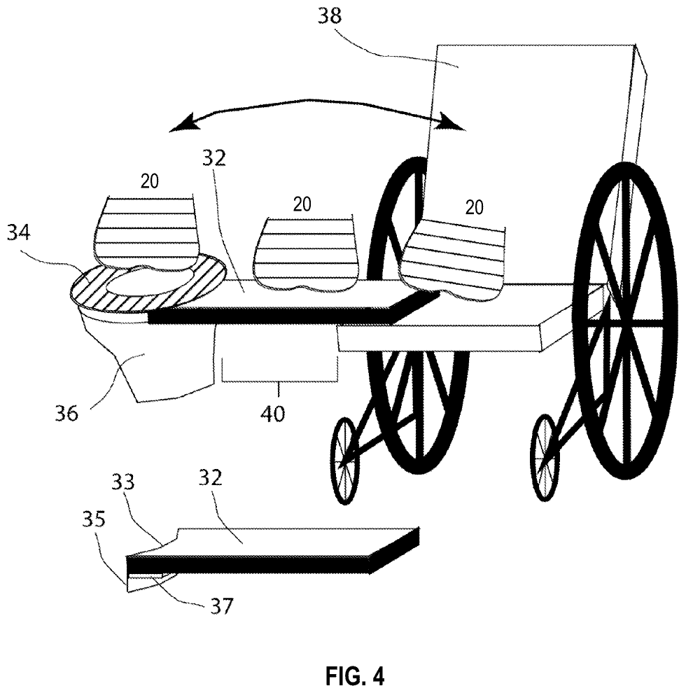

Referring to FIG. 4, a slider board 32 may be configured for transferring person 20 between a toilet 36 and a wheelchair 38 across a transfer gap 40. The slider board 32 may be specifically designed to accommodate the unique geometry and positioning requirements associated with toilet transfers. The transfer gap 40 may range from 250-375 mm (10-15 in.), and the slider board 32 may maintain structural integrity while bridging this distance between the toilet 36 and the wheelchair 38.

The slider board 32 may include a curved portion 33 configured to match and rest on the curved rim of the toilet 36 or commode base. The curved portion 33 may be shaped to conform to the contours of the toilet rim, providing stable positioning and secure placement during transfer operations. The curved portion 33 may enable the slider board 32 to rest securely on the toilet 36 without slipping or shifting during use.

As shown in FIG. 4, the slider board 32 may further comprise a gripping pad 34 positioned to enhance stability and prevent movement during transfer. The gripping pad 34 may be configured to provide additional grip against the toilet 36 surface. A nonslip lip 35 may be incorporated into the design to further secure the slider board 32 in position relative to the toilet 36. The nonslip lip 35 may prevent the slider board 32 from sliding off the toilet rim during transfer operations.

With continued reference to FIG. 4, a silicone surface 37 may be applied to the slider board 32 to prevent slipping during transfer operations. The silicone surface 37 may comprise a thin layer of RTV silicone or similar material that provides enhanced grip characteristics. The silicone surface 37 may be positioned on the curved portion 33 or other contact areas where the slider board 32 interfaces with the toilet 36. The silicone material may maintain grip properties while allowing the slider board 32 to be sanitized and sterilized after use.

The seating surface may extend across the length of the slider board 32, enabling bidirectional movement between the wheelchair 38 and the toilet 36. The wheelchair 38 may be locked in position to prevent movement during the transfer process. The slider board 32 may be positioned under the toilet seat, and all materials may be configured to withstand sanitization procedures after use. The curved design of the slider board 32 may accommodate the specific positioning requirements of toilet transfers while maintaining the structural and safety characteristics of the composite construction.

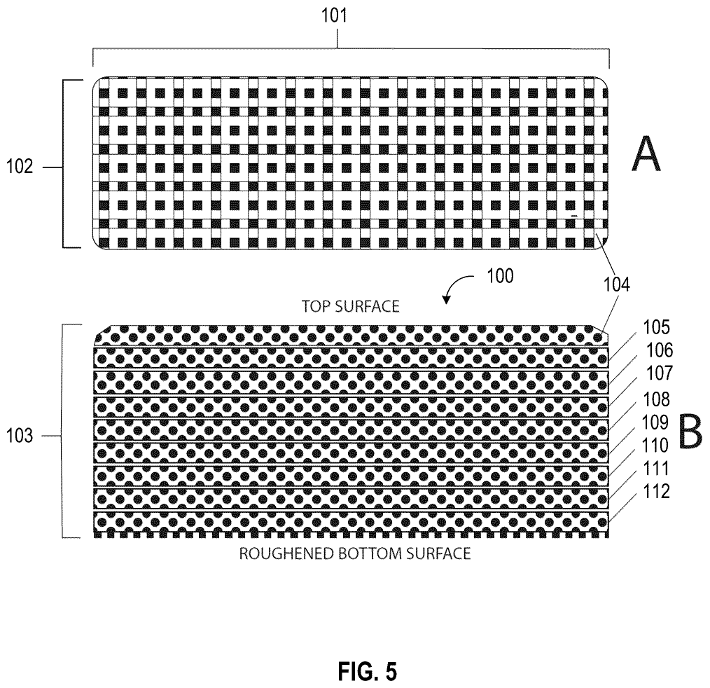

Referring to FIG. 5, an advanced composite slider board 100 may be configured with enhanced structural properties and manufacturing specifications. The slider board 100 may have a length dimension 101 of 813 mm (32 in.), a width dimension 102 of 254 mm (10 in.), and a thickness dimension 103 of about 2.5-3.5 mm (0.10-0.14 in.). The slider board 100 may weigh approximately 0.7-1.0 kg (1.6-2.2 lb.) and may be configured to support persons up to 159 kg (350 lbs.) or up to 200 kg (440 lbs.) depending on the specific configuration and layer arrangement.

The slider board 100 may comprise a nine-layer construction that provides enhanced strength and performance characteristics. As shown in FIG. 5, the layered structure may include multiple fiber reinforced materials arranged in a predetermined sequence. A glass fiber layer 104 may comprise a 1522 4 oz. E-glass material that weighs 4 oz per square yard and may have a plain weave pattern with a balanced number of glass fibers in both the warp and weft directions. The glass fiber layer 104 may serve as a first layer in the composite structure.

A carbon weave layer 105 may be positioned adjacent to the glass fiber layer 104 and may comprise a 3K 200 gsm plain weave that has a density of 200 grams per square meter. The carbon weave layer 105 may be made from bundles of 3,000 individual filaments to form carbon fiber yarn that is woven to make the fabric. The carbon weave layer 105 may provide enhanced strength characteristics to the composite structure.

With continued reference to FIG. 5, a unidirectional fiber layer 106 may comprise a C-LA-0912 vector ply unidirectional weave with long carbon fibers oriented parallel to the length dimension 101 of the slider board 100. The unidirectional fiber layer 106 may provide directional strength along the length of the slider board 100. A second unidirectional layer 107 may comprise a C-LA-0912 Vector ply unidirectional weave positioned adjacent to the unidirectional fiber layer 106.

A central unidirectional layer 108 may comprise a CL-0900 vector ply unidirectional carbon positioned at the center of the layered structure. The central unidirectional layer 108 may provide core structural support to the composite construction. A fourth unidirectional layer 109 may comprise a C-LA-0912 vector ply unidirectional weave, and a fifth unidirectional layer 110 may comprise a C-LA-0912 vector ply unidirectional weave. The fourth unidirectional layer 109 and the fifth unidirectional layer 110 may be positioned to provide symmetrical strength distribution within the composite structure.

As further shown in FIG. 5, a plain weave layer 111 may comprise a 3K 200 gsm plain weave positioned near the outer surface of the composite structure. The plain weave layer 111 may provide surface characteristics and structural integrity to the layered construction. A peel ply layer 112 may comprise an A100 Peel Ply which weighs 2.5 oz. per square yard of material. The peel ply layer 112 may be applied as a final layer during manufacturing to create a roughened surface texture.

The slider board 100 may be manufactured using vacuum assisted resin transfer molding process (VARTM). The VARTM manufacturing process may involve infusing the layered materials with a polymer resin under vacuum conditions. The polymer resin may be selected from epoxy, polyester, or thermoplastic materials. The VARTM process may enable the formation of a strong, thin, lightweight composite structure with controlled fiber-to-resin ratios.

The roughened bottom surface of the slider board 100 may be formed during manufacturing by application of the peel ply layer 112. The peel ply layer 112 may create the textured surface when removed after curing of the resin-infused materials. The peel ply texturing method may imprint a roughened pattern onto the bottom surface of the slider board 100, providing slip resistance characteristics without requiring additional post-processing steps.

The curing process may be conducted under conditions that allow the resulting slider board 100 to withstand autoclave sterilization temperatures. The composite structure may be manufactured using the vacuum assisted resin transfer molding process to enable sterilization in an autoclave. The autoclave sterilization capability may distinguish the slider board 100 from conventional wood or polymer-based slider boards that cannot withstand high-temperature sterilization procedures. The autoclave compatibility may enable the slider board 100 to be used in medical environments where sterilization procedures are required.

The manufacturing method may involve layering the multiple fiber reinforced materials in the predetermined sequence, applying the peel ply layer 112 as the final layer, infusing the layered materials with polymer resin using vacuum assisted resin transfer molding, curing the resin-infused materials to form a rigid composite structure, and removing the peel ply layer 112 after curing to reveal the roughened bottom surface. The predetermined sequence may include the glass fiber layer 104 with plain weave pattern, followed by alternating layers of carbon fiber materials with plain weave and unidirectional orientations. The composite structure may be formed to have the thickness dimension 103 of 2-6 mm and dimensions suitable for supporting loads up to 200 kg across gaps of up to 300 mm.

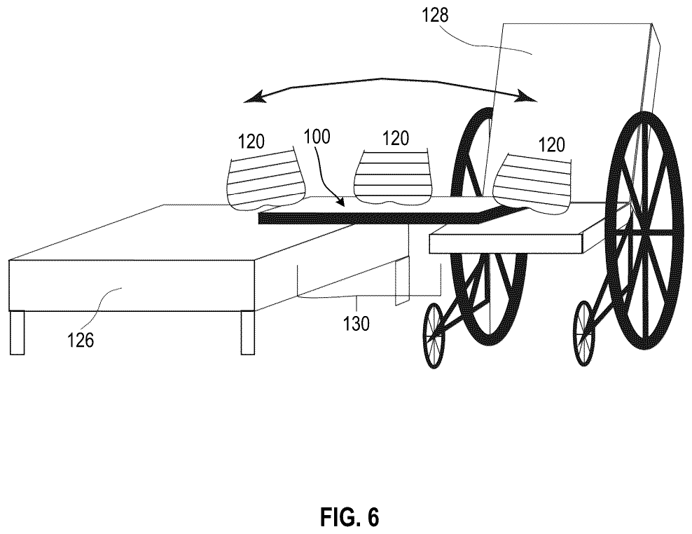

Referring to FIG. 6, the slider board 100 may be configured for practical transfer applications between seating surfaces in real-world environments. The slider board 100 may be positioned to enable transfer of a person 120 between a bed 126 and a wheelchair 128. The transfer operation may be conducted across a gap 130 that may range from 254-381 mm (10-15 in.) between the bed 126 and the wheelchair 128.

The person 120 may utilize the slider board 100 to move bidirectionally between the bed 126 and the wheelchair 128 without requiring standing or independent walking. The smooth top surface of the slider board 100 may facilitate sliding movement of the person 120 during the transfer process. The length dimension 101 of 813 mm (32 in.) and the width dimension 102 of 254 mm (10 in.) may provide adequate surface area to support the person 120 during transfer operations.

As shown in FIG. 6, the wheelchair 128 may be locked in position to prevent movement during the transfer process. The gap 130 between the bed 126 and the wheelchair 128 may be bridged by the slider board 100, which may maintain structural integrity while spanning the distance. The thin construction with the thickness dimension 103 of 2.5-3.5 mm may enable the slider board 100 to fit between seating surfaces with minimal height adjustment requirements.

With continued reference to FIG. 6, the lightweight construction of the slider board 100 weighing approximately 0.7-1.0 kg may facilitate easy positioning and repositioning by caregivers or users. The reduced weight compared to conventional wood or polymer slider boards may enable single-handed placement and removal of the slider board 100. The composite construction may provide load-bearing capacity to support the person 120 up to 159 kg (350 lbs.) while maintaining the lightweight characteristics.

The roughened bottom surface created by the peel ply layer 112 during manufacturing may provide slip resistance against the surfaces of the bed 126 and the wheelchair 128. The textured bottom surface may prevent the slider board 100 from shifting or sliding relative to the underlying surfaces during transfer operations. The slip resistance characteristics may enhance safety during the transfer process by maintaining stable positioning of the slider board 100.

The autoclave sterilization capability of the slider board 100 may enable use in medical environments where the bed 126 or the wheelchair 128 may require sterilized transfer equipment. The composite materials and manufacturing process may allow the slider board 100 to withstand high-temperature sterilization procedures without degradation of structural or surface properties. The sterilization capability may distinguish the slider board 100 from conventional transfer boards that cannot withstand autoclave temperatures.

A number of implementations have been described. Nevertheless, it will be understood that various modifications may be made without departing from the spirit and scope of the disclosure. Accordingly, other implementations are within the scope of the following claims.

1. A fiber reinforced polymer composite slider board, comprising:
a composite structure having a thickness of 2-6 mm and configured to support a person weighing up to 200 kg while bridging a gap of up to 300 mm between seating surfaces, the composite structure comprising multiple layers of fiber reinforced polymer materials including at least one layer of carbon fibers, glass fibers, or aramid fibers embedded in a polymer matrix selected from epoxy, polyester, or thermoplastic resins;
a smooth top surface configured to facilitate sliding movement of a person during transfer between seating surfaces; and
a roughened bottom surface configured to provide slip resistance against underlying surfaces during transfer operations.

2. The fiber reinforced polymer composite slider board of claim 1, wherein the composite structure has a length dimension of 500-900 mm and a width dimension of 250-400 mm.

3. The fiber reinforced polymer composite slider board of claim 1, wherein the slider board weighs between 0.7-2.7 kg.

4. The fiber reinforced polymer composite slider board of claim 1, wherein the multiple layers include unidirectional fiber layers oriented parallel to a length dimension of the slider board to provide bridging strength and torsional rigidity.

5. The fiber reinforced polymer composite slider board of claim 4, wherein the fiber layers comprise basket weave, twill, satin weave, or unidirectional fiber orientations.

6. The fiber reinforced polymer composite slider board of claim 1, wherein the polymer matrix comprises epoxy resin, polyester resin, or polyvinyl acetate resin.

7. The fiber reinforced polymer composite slider board of claim 1, wherein the roughened bottom surface is formed during manufacturing by application of a peel ply layer that creates a textured surface when removed after curing.

8. The fiber reinforced polymer composite slider board of claim 1, further comprising slip resistant pads positioned at opposing ends of the slider board, wherein the slip resistant pads comprise foam polymer materials with sculptured bottom surfaces.

9. The fiber reinforced polymer composite slider board of claim 8, wherein the slip resistant pads have a width of approximately 75 mm and a thickness of approximately 2 mm.

10. The fiber reinforced polymer composite slider board of claim 1, wherein the composite structure is manufactured using vacuum assisted resin transfer molding process to enable sterilization in an autoclave.

11. A method of manufacturing a fiber reinforced polymer composite slider board, comprising:
a step of layering multiple fiber reinforced materials in a predetermined sequence, wherein the fiber reinforced materials include at least one layer of carbon fibers, glass fibers, or aramid fibers;
a step of applying a peel ply layer as a final layer to create a roughened surface texture;
a step of infusing the layered materials with a polymer resin using vacuum assisted resin transfer molding;
a step of curing the resin-infused materials to form a rigid composite structure having a thickness of 2-6 mm and configured to support loads up to 200 kg across gaps of up to 300 mm; and
a step of removing the peel ply layer after curing to reveal the roughened bottom surface.

12. The method of claim 11, wherein the predetermined sequence includes a first layer of E-glass material with plain weave pattern, followed by alternating layers of carbon fiber materials with plain weave and unidirectional orientations.

13. The method of claim 12, wherein the carbon fiber materials comprise 3K 200 gsm plain weave layers and C-LA-0912 vector ply unidirectional weave layers.

14. The method of claim 11, wherein the polymer resin is selected from epoxy, polyester, or thermoplastic materials.

15. The method of claim 11, wherein the step of curing is conducted under conditions that allow the resulting slider board to withstand autoclave sterilization temperatures.

16. A transfer system for mobility assistance, comprising:
a fiber reinforced polymer composite slider board having a composite structure with a thickness of 2-6 mm, a length of 500-900 mm, and a width of 250-400 mm, the composite structure comprising multiple layers of fiber reinforced materials including carbon fibers or glass fibers embedded in a polymer matrix, wherein the slider board has a smooth top surface and a roughened bottom surface formed by removal of a peel ply layer during manufacturing; and
slip resistant pads positioned at opposing ends of the slider board, wherein the slip resistant pads comprise foam polymer materials with sculptured bottom surfaces configured to prevent slipping during transfer operations between seating surfaces.

17. The transfer system of claim 16, wherein the slip resistant pads have a width of approximately 75 mm and a thickness of approximately 2 mm.

18. The transfer system of claim 17, wherein the slip resistant pads comprise Ethyl Vinyl Acetate foam polymer with deeply sculptured bottom surfaces configured like boat deck pads.

19. The transfer system of claim 16, wherein the composite structure is manufactured using vacuum assisted resin transfer molding process to enable sterilization in an autoclave.

20. The transfer system of claim 16, wherein the multiple layers include unidirectional fiber layers oriented parallel to the length of the slider board to provide bridging strength and torsional rigidity for supporting loads up to 200 kg across gaps of up to 300 mm.
